(19) United States
(12) Patent Application Publication
(10) Pub. No.: US 2014/0116819 A1
(43) Pub. Date: May 1, 2014

(54) BRAKE HAVING LEVER AND IDLER BRAKE SHOES

(71) Applicant: BENDIX SPICER FOUNDATION BRAKE LLC, Elyira, OH (US)

(72) Inventor: Fred W. Berwanger, Edwardsburg, MI (US)

(73) Assignee: Bendix Spicer Foundation Brake LLC, Elyira, OH (US)

(21) Appl. No.: 13/666,576

(22) Filed: Nov. 1, 2012

(51) Int. Cl. B60T 1/06; F16D 65/08; F16D 51/36

(52) U.S. Cl. 188/79; 188/251 R

(57) ABSTRACT

A brake includes a pair of lever brake shoes and a pair of idler brake shoes. The lever brake shoes are each pivotally coupled to a brake spider at a first end. The idler brake shoes are each pivotally coupled to the brake spider at a first end and to corresponding ones of the first and second lever brake shoes at a second end. The pivotal connections to the brake spider may be different for each of the lever and idler brake shoes. An actuating member engages the second end of each of the lever brake shoes and causes the lever brake shoes and idler brake shoes to move between positions of engagement and disengagement with a braking surface. The linings on the lever brake shoes may be circumferentially nearer to the first ends of each shoe than the second end of each shoe.

### BACKGROUND OF THE INVENTION

a. Field of the Invention

This invention relates to a brake. In particular, the invention relates to a brake having an arrangement of lever and idler brake shoes that results in improved braking dynamics and less variation in braking torque.

b. Background Art

In a conventional drum brake, a brake drum rotates with a wheel or wheels proximate to one end of an axle. The drum defines a radially inner braking surface. A brake spider is disposed about the axle and a pair of brake shoes are pivotally mounted at one end to the brake spider. The opposite end of each brake shoe is engaged by an actuating member such as a cam or hydraulic piston or wedge to move the brake shoes between positions of engagement and disengagement with the braking surface of the brake drum.

Each brake shoe typically includes one or two brake linings. In brakes with two linings, one lining is nearer to the pivot point of the brake shoe and the other lining is nearer to the actuating member. When the brake is applied, the forces on the lining nearer the pivot point are substantially normal to the braking surface of the drum. The forces on the lining nearer to the actuating member, however, are at a high incidence angle relative to the braking surface. Torque reaction from the drum induces positive actuation feedback, related to the incidence, in the leading brake shoe and negative feedback in the trailing shoe, creating inconsistent brake dynamics, control and performance. Because of the location of the pivot point, the linings nearer to the actuating member must also travel further than the linings nearer the pivot point even though this additional movement results in the sub-optimal direction of force and displacement.

The inventor herein has recognized a need for a brake that will minimize and/or eliminate one or more of the above-identified deficiencies.

### BRIEF SUMMARY OF THE INVENTION

The present invention relates to a brake. In particular, the invention relates to a brake having an arrangement of lever and idler brake shoes that results in improved braking dynamics and less variation in the application of braking torque.

A brake in accordance with one embodiment of the present invention includes a brake spider having a central aperture configured to receive an axle extending therethrough. The brake further includes a first lever brake shoe pivotally coupled to the brake spider proximate a first end of the first lever brake shoe and a second lever brake shoe pivotally coupled to the brake spider proximate a first end of the second lever brake shoe. The brake further includes a first idler brake shoe pivotally coupled to the brake spider proximate a first end of the first idler brake shoe and coupled to the first lever brake shoe proximate a second end of the first idler brake shoe. The brake further includes a second idler brake shoe pivotally coupled to the brake spider proximate a first end of the second idler brake shoe and coupled to the second lever brake shoe proximate a second end of the second idler brake shoe. The brake further includes an actuating member in engagement with a second end of each of the first and second lever brake shoes. Movement of the actuating member causes the first and second lever brake shoes and the first and second idler brake shoes to move between positions of engagement and disengagement with a braking surface. A brake lining on the first lever brake shoe is circumferentially nearer to the first end of the first lever brake shoe than the second end of the first lever brake shoe.

A brake in accordance with another embodiment of the present invention includes a brake spider having a central aperture configured to receive an axle extending therethrough. The brake further includes a first lever brake shoe pivotally coupled to the brake spider at a first pivot point proximate a first end of the first lever brake shoe and a second lever brake shoe pivotally coupled to the brake spider at a second pivot point proximate a first end of the second lever brake shoe. The brake further includes a first idler brake shoe pivotally coupled to the brake spider at a third pivot point proximate a first end of the first idler brake shoe, the third pivot point different than the first pivot point, and coupled to the first lever brake shoe proximate a second end of the first idler brake shoe. The brake further includes a second idler brake shoe pivotally coupled to the brake spider at a fourth pivot point proximate a first end of the second idler brake shoe, the fourth pivot point different than the second pivot point, and coupled to the second lever brake shoe proximate a second end of the second idler brake shoe. The brake further includes an actuating member in engagement with a second end of each of the first and second lever brake shoes. Movement of the actuating member causes the first and second lever brake shoes and the first and second idler brake shoes to move between engagement positions and disengagement positions

A brake in accordance with another embodiment of the present invention includes a first lever brake shoe having a first end configured to pivot about a first pivot point and a second lever brake shoe having a first end configured to pivot about a second pivot point. The brake further includes a first idler brake shoe having a first end configured to pivot about a third pivot point, the third pivot point different than the first pivot point, and a second end coupled to the first lever brake shoe. The brake further includes a second idler brake shoe having a first end configured to pivot about a fourth pivot point, the fourth pivot point different than the second pivot point, and a second end coupled to the second lever brake shoe. The brake further includes an actuating member in engagement with a second end of each of the first and second lever brake shoes. Movement of the actuating member causes the first and second lever brake shoes and the first and second idler brake shoes to move between engagement positions and disengagement positions.

A brake in accordance with the present invention represents an improvement relative to conventional brakes. Each of the brake linings acts in a direction substantially normal to the braking surface of the drum. As a result, torque gain variation is improved because there is a reduction in positive and negative actuation feedback in the leading and trailing brake shoes. The use of multiple leading and trailing brake shoes also improves torque gain variation through an averaging effect relative to conventional brakes having a single leading shoe and a single trailing shoe. Braking dynamics are also improved. The axisymmetric arrangement of the leading and trailing brake shoes provides improved balance of static and dynamic forces with axisymmetric distribution of actuation, drag and reaction forces improving brake response. The interface between the lever and idler brake shoes also helps to dampen vibrations. The inventive brake also increases the mechanical advantage in the tension springs used to retract the brake shoes and at the actuating member/brake shoe interface. In the case of a cam actuating member, a steeper cam involute angle can therefore be used to generate greater travel in cam followers per radian of cam rotation thereby reducing air chamber stroke on each brake application and air consumption. Alternatively, with a conventional cam angle and smaller diameter air chamber, structural loads in the cam and cam bracket can be reduced. The width of the cam and cam followers can also be reduced thereby enabling the use of cam follower pins that are longer and have a smaller diameter and thereby reducing friction. Further still, relatively low-friction bearing materials can be used at the interface between the brake shoes webs and follower pin trunnions and lower-friction brake lining materials having other beneficial properties may also be used.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a plan view of a portion of a brake in accordance with one embodiment of the present invention.

FIG. 2 is a cross-sectional view of the interconnection of a lever brake shoe and a idler brake shoe in accordance with one embodiment of the present invention.

FIG. 3 is a plan view of the interconnection of a lever brake shoe and a idler brake shoe shown in FIG. 2 taken along lines 3-3.

FIG. 4 is a cross-sectional view of the interconnection of a lever brake shoe and a idler brake shoe in accordance with another embodiment of the present invention.

FIG. 5 is a cross-sectional view of the interconnection of a lever brake shoe and a idler brake shoe in accordance with another embodiment of the present invention.

FIG. 6 is a cross-sectional view of the interconnection of a lever brake shoe and a idler brake shoe in accordance with another embodiment of the present invention.

### DETAILED DESCRIPTION OF THE INVENTION

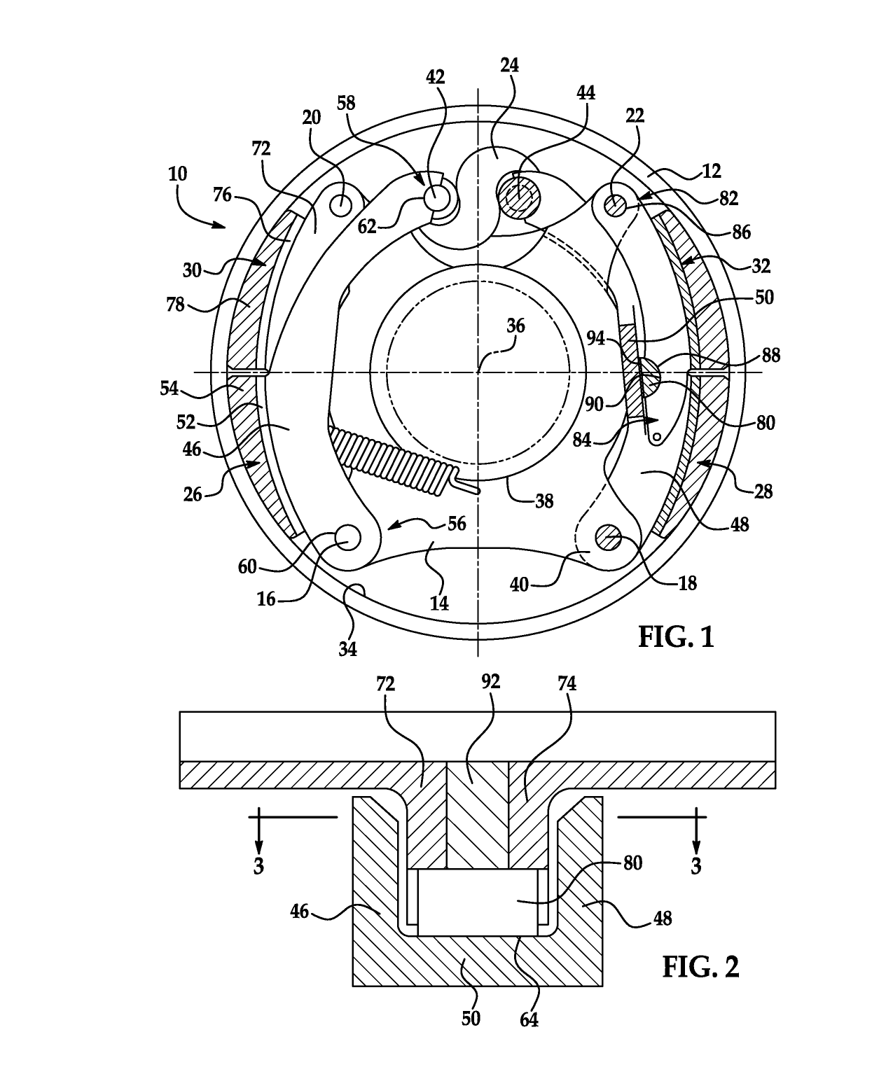

Referring now to the drawings wherein like reference numerals are used to identify identical components in the various views, FIG. 1 illustrates a brake 10 in accordance with one embodiment of the present invention. Brake 10 is particularly adapted for use in heavy trucks. It should be understood, however, that brake 10 may be used on a wide variety of vehicles and in non-vehicular applications. Brake 10 is configured to act against a brake drum 12 and may include a brake spider 14, a plurality of anchors 16, 18, 20, 22, an actuating member 24, and a pair of lever brake shoes 26, 28 and idler brake shoes 30, 32.

Brake drum 12 provides a braking surface 34 and is conventional in the art. Drum 12 may be made from conventional metals and metal alloys such as steel or cast iron. Drum 12 is annular and rotates with the vehicle wheel or wheels at one end of an axle about a central axis 36 extending through the axle (and into and out of drawing in FIG. 1).

Brake spider 14 is provided to mount the various components of brake 10. Spider 14 defines a central aperture 38 through which the vehicle axle may extend. Spider 14 also supports anchors 16, 18, 20, 22 and brake shoes 26, 28, 30, 32. In the illustrated embodiment, spider 14 defines a plurality of flanges 40 each of which are configured to receive one of anchors 16, 18, 20 22. Spider 14 may further include an aperture through which a camshaft (not shown) supporting actuating member 24 extends.

Anchors 16, 18, 20, 22 are provided to pivotally mount brake shoes 26, 28, 30, 32, respectively. Anchors 16, 18, 20, 22 are conventional in the art and are supported on spider 14. Anchors 16, 18, 20, 22 may comprise round pins that extends axially from spider 14. In accordance with one aspect of the present invention, anchors 16, 18, 20, 22 establish different pivot points for each of brake shoes 26, 28, 30, 32. Anchors 16, 18 for lever brake shoes 26, 28 are located on one side of the axle furthest from actuating member 24 while anchors 20, 22 for idler brake shoes 30, 32 are located on the side of the axle nearer actuating member 24. Anchors 16, 22 may be located diametrically opposite one another and anchors 18, 20 may likewise be located diametrically opposite one another.

Actuating member 24 is provided to cause movement of brake shoes 26, 28, 30, 32 between positions of engagement with and disengagement from braking surface 34 of drum 12. In the illustrated embodiment, actuating member 24 comprises a conventional doubled lobed S-cam. Cam followers 42, 44 coupled to one end of lever brake shoes 26, 28, respectively, follow the surface of actuating member 24 as it rotates thereby causing shoes 26, 28 to pivot about anchors 16, 18. Although actuating member 24 comprises an S-cam in the illustrated embodiment, it should be understood that conventional fluid actuated pistons or a wedge type mechanism may also be employed to move shoes 26, 28, 30, 32 between positions of engagement with and disengagement from braking surface 34.

Lever brake shoes 26, 28 are provided for selective engagement with braking surface 34 of drum 12 in order to apply a braking torque to drum 12 and one or more wheels. One of brake shoes 26, 28 may comprise a leading brake shoe while the other may comprise a trailing brake shoe. Each of lever brake shoes 26, 28 may include a pair of spaced webs 46, 48 (one of the webs has been removed from brake shoe 28 in FIG. 1 to better illustrate various aspects of the invention), a cross member 50 (best shown in FIG. 2) extending between webs 46, 48, a brake table 52, and a brake lining 54.

Webs 46, 48 are provided to support brake table 52 and may extend generally parallel to one another. Webs 46, 48 may be made from metals and metal alloys such as steel. Referring to FIG. 1, webs 46, 48 are arcuate in shape and each web defines opposed ends 56, 58 of the brake shoes 26, 28. Webs 46, 48 and may define aligned circular apertures 60 proximate end 56 configured to receive a corresponding one of anchors 16, 18 such that brake shoes 26, 28 are pivotally coupled to brake spider 14 proximate end 56. Webs 46, 48 may further define aligned semicircular recesses 62 proximate end 58 configured to receive a corresponding one of cam followers 42, 44.

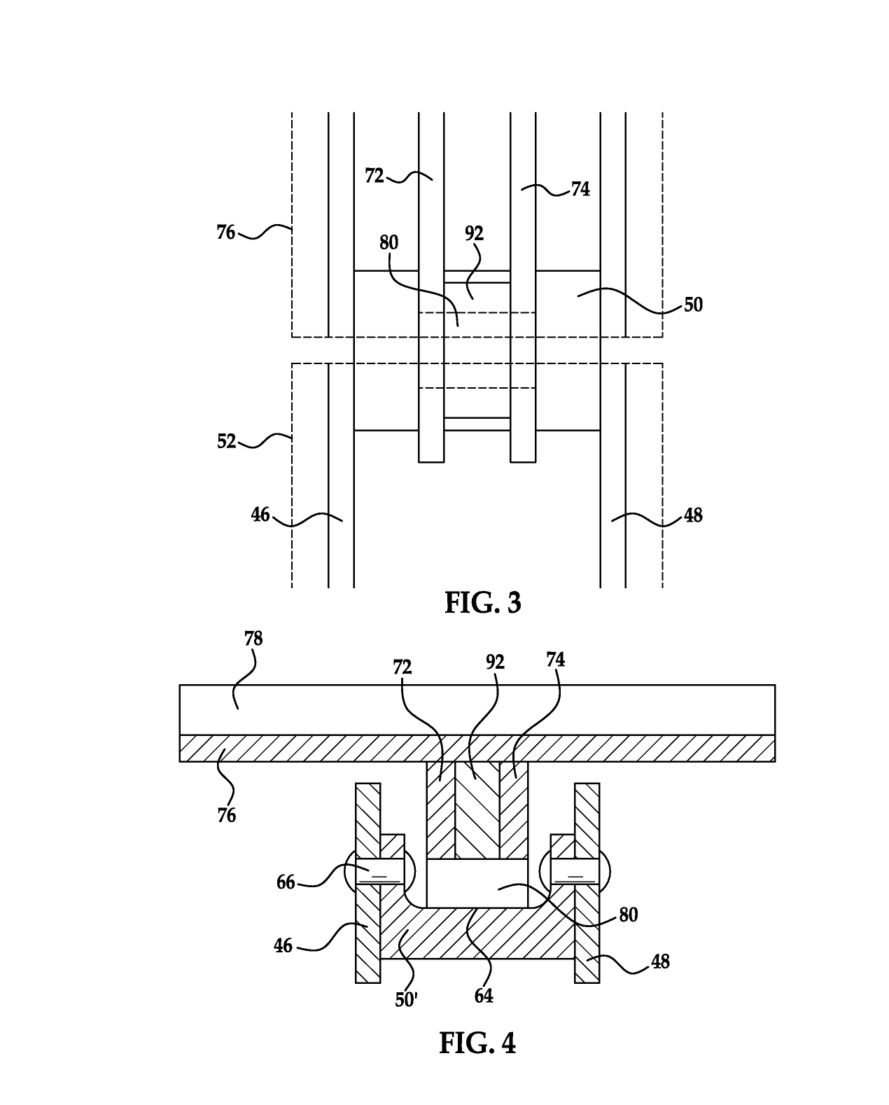

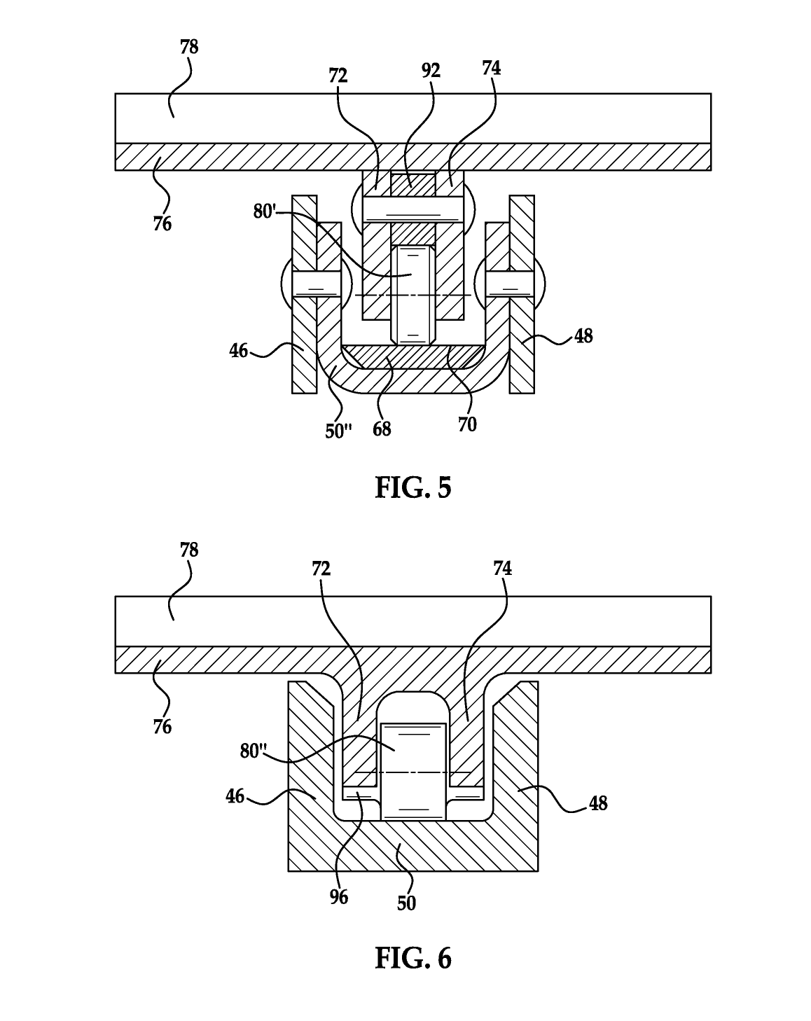

Referring to FIG. 2, cross member 50 provides a bearing surface 64 for a purpose described hereinbelow. Member 50 may be integrated with webs 46, 48 to form a unitary body (e.g., a one-piece casting). Referring to FIG. 4, in an alternative embodiment, cross member 50′ may be generally C-shaped in cross-section and may be connected at either end to webs 46, 48 using conventional fasteners 66 such as rivets. Referring to FIG. 5, in yet another alternative embodiment, a cross member 50″ may support a bearing block 68 defining a bearing surface 70.

Referring again to FIG. 1, brake table 52 is provided to support brake lining 54. Table 52 may be made from conventional metals and metal alloys including steel. Table 52 is arcuate in shape any may be secured to webs 46, 48 using welds or other conventional fastening means.

Brake lining 54 is provided for frictional engagement with braking surface 34 of drum 12. Lining 54 may be made from conventional friction materials. Brake lining 54 may be secured to brake table 52 using a plurality of rivets or other conventional fasteners. In accordance with one aspect of the present invention the brake lining 54 on each lever brake shoe 26, 28 may be circumferentially nearer to end 56 of lever brake shoe 26, 28 than end 58 and, in particular, is nearer to the pivot points provided by anchors 16, 18 than to actuating member 24.

Referring to FIGS. 1-3, idler brake shoes 30, 32 are also provided for selective engagement with braking surface 34 of drum 12 in order to apply a braking torque to drum 12 and one or more wheels. One of brake shoes 30, 32 may comprise a leading brake shoe while the other may comprise a trailing brake shoe. Each of idler brake shoes 30, 32 may include a pair of spaced webs 72, 74, a brake table 76, a brake lining 78, and a bearing 80.

Webs 72, 74 are provided to support brake table 76 and may extend generally parallel to one another. Webs 72, 74 may again be made from metals and metal alloys such as steel. Referring to FIG. 1, webs 72, 74 are arcuate in shape and define ends 82, 84 of each brake shoe 30, 32. Webs 72, 74 may define aligned circular apertures 86 proximate one end configured to receive a corresponding one of anchors 20, 22 such that brake shoes 30, 32 are pivotally coupled to brake spider 14 proximate end 82 of each brake shoe. Referring to FIGS. 2-3, the webs 72, 74 of a idler brake shoe 30, 32 may be disposed between webs 46, 48 of a corresponding lever brake shoe 26, 28. Referring again to FIG. 1, webs 72, 74, may extend underneath the brake table 52 of the corresponding lever brake shoe 26, 28 and define aligned semicircular recesses 88 proximate end 84 configured to receive bearing 80 such that brake shoes 30, 32 are coupled to lever brake shoes 26, 28 proximate end 84 of brake shoes 30, 32. Webs 72, 74 may also provide a connection point for tension springs used to retain brake shoes 30, 32 in engagement with bearing 80 and return springs used to bias brake shoes 26, 28, 30, 32 to a position of disengagement from braking surface 34.

Brake table 76 is provided to support brake lining 78. Table 76 may be made from conventional metals and metal alloys including steel. Table 76 is arcuate in shape any may be secured to webs 72, 74 using welds or other conventional fastening means. Referring to FIG. 2, table 76 may be disposed radially outwardly of webs 46, 48 of lever brake shoe 26, 28.

Brake lining 78 is provided for frictional engagement with braking surface 34 of drum 12. Lining 78 may be made from conventional friction materials. Brake lining 78 may be secured to brake table 76 using a plurality of rivets or other conventional fasteners. In accordance with one aspect of the present invention, brake lining 78 is disposed near the pivot point of the brake shoe 30, 32. Further, at least a portion of lining 78 on idler brake shoe 30 is diametrically opposite a portion of lining 52 on lever brake shoe 28 while a portion of lining 78 on idler brake shoe 32 is diametrically opposite a portion of lining 52 on lever brake shoe 26.

Bearing 80 provides a means for translating movement of a lever brake shoe 26, 28 into corresponding movement of a idler brake shoe 30, 32. Referring to FIG. 1, bearing 80 may comprise a semicircular (or half-round) bearing, having a rounded surface 90 in engagement with recesses 88 in webs 72, 74 of brake shoe 30, 32 and a bearing surface formed in a bearing plate 92 (see FIG. 2) sandwiched between webs 72, 74, and a flat surface 94 in engagement with bearing surface 64 of cross member 50. Pivotal movement of a lever brake shoe 26, 28 about a corresponding anchor 16, 18 will cause bearing 80 to slide across bearing surface 64 of cross member 50 and cause idler brake shoe 30, 32 to pivot about anchor 20, 22 and slide around surface 90 of bearing 80 as brake shoe 30, 32 moves into engagement with braking surface 34 of drum 12. Referring to FIG. 5, in accordance with another embodiment of the invention, a bearing 80′ may instead comprise a roller (i.e. without a flat surface as in bearing 80) that is held loosely between webs 72, 74 and between bearing surface 70 of bearing plate 68 and bearing plate 92 or may be mounted on an axle extending into webs 72, 74. In the illustrated embodiment, bearing 80′ is in contact with both bearing surface 70 and bearing plate 92. Referring to FIG. 6, in yet another alternative embodiment, a bearing 80″ may comprise a roller that is in contact with only bearing surface 64. In this embodiment, bearing 80″ may include flanges 96 extending from either side configured to be engaged by webs 72, 74 of brake shoe 30, 32.

Referring again to FIG. 1, the operation of brake 10 will be described. When the brake is actuated, rotation of actuating member 24 causes lever brake shoes 26, 28 to pivot about anchors 16, 18 thereby urging lever brake shoes towards a position of engagement with braking surface 34 of drum 12. Movement of lever brake shoes 26, 28, and particularly cross member 50, is translated into corresponding movement of idler brake shoes 30, 32 through the interaction of bearing 80, 80′, or 80″ with cross member 50, 50′, or 50″ thereby causing brake shoes 30, 32 to pivot about anchors 20, 22 and towards engagement with braking surface 34.

A brake in accordance with the present invention has several advantages relative to conventional brakes. The brake linings 52 on shoes 26, 28 and the brake linings 78 on shoes 30, 32 all act in a direction substantially normal to the braking surface 34 of drum 12. As a result, torque gain variation is improved because there is a reduction in positive and negative actuation feedback in the leading and trailing brake shoes. The use of multiple leading and trailing brake shoes 26, 28, 30, 32 also improves torque gain variation through an averaging effect relative to conventional brakes having a single leading shoe and a single trailing shoe. The inventive brake also results in improved braking dynamics. The axisymmetric arrangement of the leading brake shoes and trailing brake shoes provides improved balance of static and dynamic forces with axisymmetric distribution of actuation, drag and reaction forces improving brake response. The interface between the lever and idler brake shoes 26, 28, 30, 32 also helps to dampen vibrations. The inventive brake 10 also increases the mechanical advantage in the tension springs used to retract the brake shoes 26, 28, 30, 32 and at the interface of actuating member 24. In the case of a cam actuating member, a steeper cam involute and therefore be used to generate greater travel in the cam followers per radian of cam rotation thereby reducing air chamber stroke on each brake application and air consumption. Alternatively, with a conventional cam angle and smaller diameter air chamber, structural loads in the cam and cam bracket can be reduced. The width of the cam and cam followers can also be reduced thereby enabling the use of cam follower pins that are longer and have a smaller diameter and thereby reducing friction. Further still, relatively low-friction bearing materials can be used at the interface between the brake shoes webs 46, 48, 72, 74 and follower pin trunnions and lower-friction lining materials having other beneficial properties may also be used.

While the invention has been shown and described with reference to one or more particular embodiments thereof, it will be understood by those of skill in the art that various changes and modifications can be made without departing from the spirit and scope of the invention.

What is claimed is:

1. A brake, comprising:
a brake spider having a central aperture configured to receive an axle extending therethrough;
a first lever brake shoe pivotally coupled to said brake spider proximate a first end of said first lever brake shoe;
a second lever brake shoe pivotally coupled to said brake spider proximate a first end of said second lever brake shoe;
a first idler brake shoe pivotally coupled to said brake spider proximate a first end of said first idler brake shoe and coupled to said first lever brake shoe proximate a second end of said first idler brake shoe;
a second idler brake shoe pivotally coupled to said brake spider proximate a first end of said second idler brake shoe and coupled to said second lever brake shoe proximate a second end of said second idler brake shoe; and,
an actuating member in engagement with a second end of each of said first and second lever brake shoes, movement of said actuating member causing said first and second lever brake shoes and said first and second idler brake shoes to move between positions of engagement and disengagement with a braking surface
wherein a brake lining on said first lever brake shoe is circumferentially nearer to said first end of said first lever brake shoe than said second end of said first lever brake shoe.

2. The brake of claim 1 wherein a brake lining on said second lever brake shoe is circumferentially nearer to said first end of said second lever brake shoe than said second end of said second lever brake shoe.

3. The brake of claim 1 wherein a portion of said brake lining of said first lever brake shoe is diametrically opposite a portion of a brake lining of said second idler brake shoe.

4. The brake of claim 3 wherein a portion of a brake lining of said second lever brake shoe is diametrically opposite a portion of a brake lining of said first idler brake shoe.

5. The brake shoe of claim 1 wherein each of said first lever brake shoe and said first idler brake shoe includes first and second webs and a brake table supported on said first and second webs, said first and second webs of said first idler brake shoe disposed between said first and second webs of said first lever brake shoe.

6. The brake shoe of claim 5 wherein a portion of said brake table of said first idler brake shoe is disposed radially outwardly of said first and second webs of said first lever brake shoe.

7. The brake shoe of claim 1 wherein said first lever brake shoe includes first and second webs spaced from one another and a cross member extending between said first and second webs, said cross member defining a bearing surface, and said first idler brake shoe includes a bearing configured to engage said bearing surface.

8. The brake shoe of claim 7 wherein said bearing comprises a roller.

9. The brake shoe of claim 7 wherein said bearing includes a rounded surface in engagement with said first idler brake shoe and a flat surface in engagement with said bearing surface.

10. The brake shoe of claim 1 wherein said first lever brake shoe and said second idler brake shoe comprise leading brake shoes.

11. A brake, comprising:
a brake spider having a central aperture configured to receive an axle extending therethrough;
a first lever brake shoe pivotally coupled to said brake spider at a first pivot point proximate a first end of said first lever brake shoe;
a second lever brake shoe pivotally coupled to said brake spider at a second pivot point proximate a first end of said second lever brake shoe;
a first idler brake shoe pivotally coupled to said brake spider at a third pivot point proximate a first end of said first idler brake shoe, said third pivot point different than said first pivot point, and coupled to said first lever brake shoe proximate a second end of said first idler brake shoe;
a second idler brake shoe pivotally coupled to said brake spider at a fourth pivot point proximate a first end of said second idler brake shoe, said fourth pivot point different than said second pivot point, and coupled to said second lever brake shoe proximate a second end of said second idler brake shoe; and,
an actuating member in engagement with a second end of each of said first and second lever brake shoes, movement of said actuating member causing said first and second lever brake shoes and said first and second idler brake shoes to move between engagement positions and disengagement positions.

12. The brake of claim 11 wherein a brake lining on said first lever brake shoe is circumferentially nearer to said first end of said first lever brake shoe than said second end of said first lever brake shoe.

13. The brake of claim 12 wherein a brake lining on said second lever brake shoe is circumferentially nearer to said first end of said second lever brake shoe than said second end of said second lever brake shoe.

14. The brake of claim 11 wherein a portion of a brake lining of said first lever brake shoe is diametrically opposite a portion of a brake lining of said second idler brake shoe.

15. The brake of claim 14 wherein a portion of a brake lining of said second lever brake shoe is diametrically opposite a portion of a brake lining of said first idler brake shoe.

16. The brake shoe of claim 11 wherein each of said first lever brake shoe and said first idler brake shoe includes first and second webs and a brake table supported on said first and second webs, said first and second webs of said first idler brake shoe disposed between said first and second webs of said first lever brake shoe.

17. The brake shoe of claim 16 wherein a portion of said brake table of said first idler brake shoe is disposed radially outwardly of said first and second webs of said first lever brake shoe.

18. The brake shoe of claim 11 wherein said first lever brake shoe includes first and second webs spaced from one another and a cross member extending between said first and second webs, said cross member defining a bearing surface, and said first idler brake shoe includes a bearing configured to engage said bearing surface.

19. The brake shoe of claim 18 wherein said bearing comprises a roller.

20. The brake shoe of claim 18 wherein said bearing includes a rounded surface in engagement with said first idler brake shoe and a flat surface in engagement with said bearing surface.

21. The brake shoe of claim 11 wherein said first lever brake shoe and said second idler brake shoe comprise leading brake shoes.

22. A brake, comprising:
a first lever brake shoe having a first end configured to pivot about a first pivot point;
a second lever brake shoe having a first end configured to pivot about a second pivot point;
a first idler brake shoe having a first end configured to pivot about a third pivot point, said third pivot point different than said first pivot point, and a second end coupled to said first lever brake shoe;
a second idler brake shoe having a first end configured to pivot about a fourth pivot point, said fourth pivot point different than said second pivot point, and a second end coupled to said second lever brake shoe; and,
an actuating member in engagement with a second end of each of said first and second lever brake shoes, movement of said actuating member causing said first and second lever brake shoes and said first and second idler brake shoes to move between engagement positions and disengagement positions.

23. The brake of claim 22 wherein a brake lining on said first lever brake shoe is circumferentially nearer to said first end of said first lever brake shoe than said second end of said first lever brake shoe.

24. The brake shoe of claim 22 wherein said first lever brake shoe includes first and second webs spaced from one another and a cross member extending between said first and second webs, said cross member defining a bearing surface, and said first idler brake shoe includes a bearing configured to engage said bearing surface.

25. The brake shoe of claim 24 wherein said bearing comprises a roller.

26. The brake shoe of claim 24 wherein said bearing includes a rounded surface in engagement with said first idler brake shoe and a flat surface in engagement with said bearing surface.
